(19) United States
(12) Patent Application Publication
(10) Pub. No.: US 2026/0290239 A1
(43) Pub. Date: Sep. 24, 2026

(54) DISPLAY DEVICE

(71) Applicant: SHARP DISPLAY TECHNOLOGY CORPORATION, Kameyama City, Mie (JP)

(72) Inventors: Hiroyuki FURUKAWA, Kameyama City (JP); Masafumi UENO, Kameyama City (JP)

(21) Appl. No.: 19/490,146

(22) PCT Filed: Aug. 31, 2023
(86) PCT No.: PCT/JP2023/031787

§ 371 Date: Dec. 4, 2025

(51) Int. Cl. G09G 3/3233; G09G 3/32

(52) U.S. Cl. CPC G09G 3/3233; G09G 3/32; G09G 2320/0271; G09G 2320/0633; G09G 2320/0673

(57) ABSTRACT

A display device (10) includes a display section (20) and a control section (30) that controls the display section, the display section having a unit area (5) including N light-emitting elements that emit light of a first color and the control section (30) controlling the unit area (5) such that, in a case where a display gradation level of the first color in the unit area (5) is to be a first low gradation level which is higher than zeroth gradation level and lower than a threshold gradation level, the N light-emitting elements include a light-emitting element that is lit and a light-emitting element that is unlit.

### TECHNICAL FIELD

The present disclosure relates to a display device and a method for controlling the display device.

### BACKGROUND ART

Document 1 discloses a display method using sub-frame division and area coverage modulation in combination.

### CITATION LIST

### Patent Literature

### [Patent Literature 1]

Japanese Patent Application Publication, Tokukai, No. 2006-39039.

### SUMMARY

### Technical Problem

A known display device including light-emitting elements had a problem in that quality of display in a low gradation range was low.

### Solution to Problem

A display device according to the present disclosure includes a display section and a control section that controls the display section, the display section having a unit area including N light-emitting elements that emit light of a first color, where N is an integer of 2 or more, and the control section controlling the unit area such that, in a case where a display gradation level of the first color in the unit area is set to a first low gradation level that is higher than zeroth gradation level and lower than the threshold gradation level, the N light-emitting elements include a light-emitting element which is lit and a light-emitting element which is unlit.

### Advantageous Effects of Disclosure

In a display device including light-emitting elements, the quality of display in a low gradation range is increased.

### BRIEF DESCRIPTION OF DRAWINGS

FIG. 1 is a schematic view illustrating a configuration example of a display device in accordance with the present

FIG. 2 is a cross sectional view illustrating a configuration example of the display section.

FIG. 3 is a graph showing a characteristic of a light-emitting element.

FIG. 4 is a plan view illustrating a configuration example of the display section.

FIG. 5 is a circuit diagram illustrating a configuration example of a pixel circuit that is connected to the light-emitting element.

FIG. 6 is a schematic cross sectional view illustrating a relationship between an effective luminance of an upper light-emitting element and an effective luminance of a lower light-emitting element.

FIG. 7 is a schematic cross sectional view illustrating a relationship between the effective luminance of the upper light-emitting element and the effective luminance of the lower light-emitting element.

FIG. 8 is a schematic view illustrating light emission patterns of a plurality of light-emitting elements which are included in a unit area.

FIG. 9 is a schematic view illustrating light emission patterns of the plurality of light-emitting elements which are included in the unit area.

FIG. 10 is a graph showing a relationship between a display gradation level in a low gradation range and a sum of luminance in a unit area.

FIG. 11 is a flowchart showing a method for controlling the display device.

FIG. 12 is a schematic view illustrating light emission patterns of a plurality of light-emitting elements which are included in a unit area.

FIG. 13 is a schematic view illustrating light emission patterns of the plurality of light-emitting elements which are included in the unit area.

FIG. 14 is a graph showing a relationship between a display gradation level in the low gradation range and a sum of luminance in a unit area.

FIG. 15 is a cross sectional view illustrating a configuration example of a display section.

FIG. 16 is a plan view illustrating a configuration example of a display section.

FIG. 17 is a cross sectional view illustrating a configuration example of the display section.

### DESCRIPTION OF EMBODIMENTS

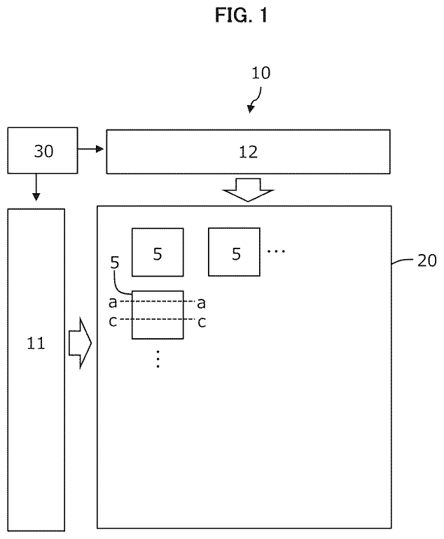

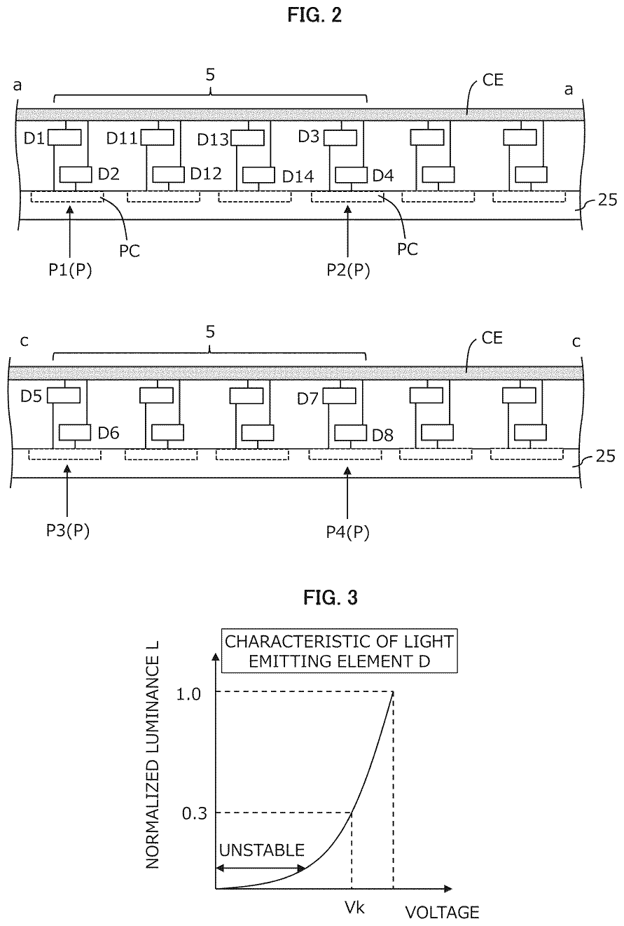

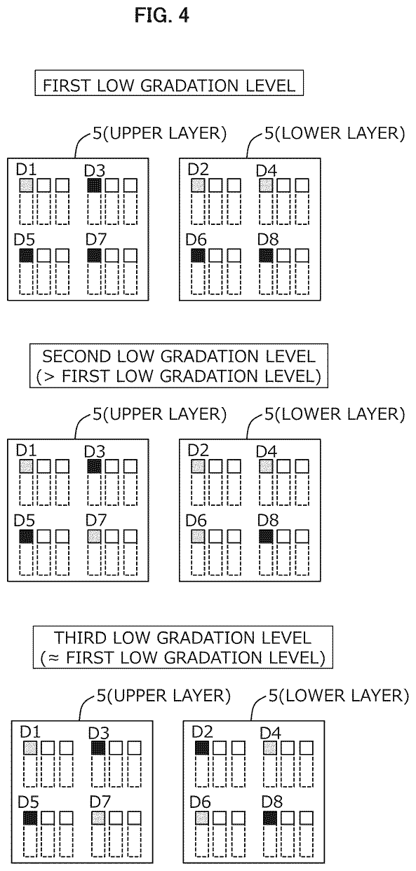

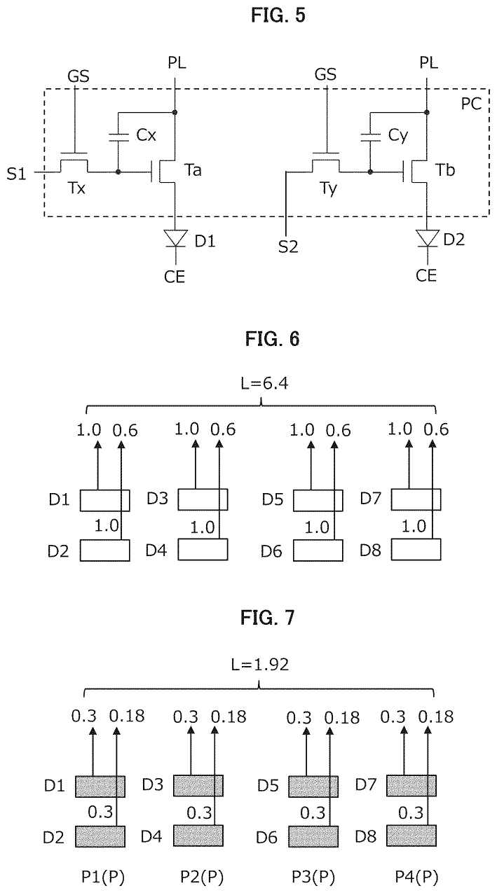

FIG. 1 is a schematic view illustrating a configuration example of a display device in accordance with the present embodiment. FIG. 2 is a cross sectional view illustrating a configuration example of the display section. FIG. 3 is a graph showing a characteristic of a light-emitting element. FIG. 4 is a plan view illustrating a configuration example of the display section. FIG. 5 is a circuit diagram illustrating a configuration example of a pixel circuit that is connected to the light-emitting element.

As illustrated in FIGS. 1 to 5, a display device 10 includes a display section 20 and a control section 30 that controls the display section 20, the display section 20 having a unit area 5 including N light-emitting elements (for example, eight light-emitting elements D1 to D8) that emit light of a first color and the control section 30 controlling the unit area (5) such that, in a case where a display gradation level of the first color in the unit area 5 is to be set to a first low gradation level which is higher than zeroth gradation level and lower than a threshold gradation level, the N light-emitting elements (for example, the eight light-emitting elements D1 to D8) include light-emitting elements (e.g., D1, D2, and D4) that are lit and light-emitting elements (e.g., D3, D5, D6, D7, and D8) that are unlit.

The display device 10 may include a first driver 11 and a second driver 12 that drive the display section 20, and the control section 30 may control the first driver 11 and the second driver 12. The unit area 5 of the display section 20 may include a plurality of sub-pixels (for example, four sub-pixels P1 to P4) that emits light of the first color. In this way, in the case where display in a low gradation range is carried out, quality of display in the low gradation range can be increased by area coverage modulation display (dithered display) for each unit area 5.

The N light-emitting elements (for example, the eight light-emitting elements D1 to D8) may consist of one or more upper light-emitting elements (for example, four light-emitting elements D1, D3, D5, and D7) and one or more lower light-emitting elements (for example, four light-emitting elements D2, D4, D6, and D8) that overlap with the one or more upper light-emitting elements in plan view.

As illustrated in FIG. 2, in the unit area 5, layered light-emitting elements D1 and D2 (the light-emitting element D1 is on an upper side), layered light-emitting elements D3 and D4 (the light-emitting element D3 is on the upper side), layered light-emitting elements D5 and D6 (the light-emitting element D5 is on the upper side), and layered light-emitting elements D7 and D8 (the light-emitting element D7 is on the upper side) may be provided between a pixel circuit substrate 25 and a common electrode CE. With regard to the sub-pixels P1 to P4 of the same color, the sub-pixel P1 may include the light-emitting elements D1 and D2, the sub-pixel P2 may include the light-emitting elements D3 and D4, the sub-pixel P3 may include the light-emitting elements D5 and D6, and the sub-pixel P4 may include the light-emitting elements D7 and D8.

The pixel circuit substrate 25 may include a pixel circuit PC as illustrated in FIG. 5. For example, the pixel circuit PC includes a drive transistor Ta and a writing transistor Tx, and a capacitor element Cx. The drive transistor Ta has a source terminal that is connected to a gate terminal of the drive transistor Ta via the capacitor element Cx, and the light-emitting element D1 has an anode that is connected to a high-potential-side power source line PL (ELVDD line) via the drive transistor Ta. In the case of dithered display, a data voltage S1 is written to the capacitor element Cx via the writing transistor Tx. The data voltage S1 may assume two discrete values. The common electrode CE may function as a cathode of the light-emitting element D1. Similarly, the pixel circuit PC includes a drive transistor Tb and a writing transistor Ty, and a capacitor element Cy. The drive transistor Tb has a source terminal that is connected to a gate terminal of the drive transistor Tb via the capacitor element Cy, and the light-emitting element D2 has an anode that is connected to the high-potential-side power source line PL (ELVDD line) via the drive transistor Tb. In the case of dithered display, a data voltage S2 is written to the capacitor element Cy via the writing transistor Ty. The data voltage S2 may assume two discrete values. The common electrode CE may function as a cathode of the light-emitting element D2. Scanning signals GS that are inputted to the gate terminals of the writing transistors Tx and Ty may be common to both of the gate terminals.

In a case where an organic light emitting diode or a quantum dot light-emitting diode is used as a light-emitting element D (a collective name for the light-emitting elements D1 to D8), luminance in a low-voltage range (provided that the maximum luminance in the specification of the light-emitting element D is set to a normalized luminance of 1.0, for example, a low luminance range of 0 to 0.2) is likely to be unstable as shown in FIG. 3. In light of this, in the dithered display, it is preferable to light the light-emitting element D at a stable luminance (for example, at a normalized luminance of 0.3 corresponding to voltage Vk).

As illustrated in FIG. 4, in a case where the display gradation level in the unit area 5 is a second low gradation level that is higher than the first low gradation level and lower than the threshold gradation level, the number of light-emitting elements (e.g., D1, D2, D4, D6, and D7) that are lit may be larger than that in a case where the display gradation level is the first low gradation level. The luminance of the light-emitting elements that are lit may not be change between a case where the display gradation level is the first low gradation level and a case where the display gradation level is the second low gradation level. For example, the light-emitting element D1 illustrated in FIG. 4 may emit light at the same luminance in the case where the display gradation level is the first low gradation level and in the case where the display gradation level is the second low gradation level.

As illustrated in FIG. 4, in a case where the display gradation level in the unit area 5 is the first low gradation level, the number of the upper light-emitting elements (e.g., D1) that are lit may differ from the number of lower light-emitting elements (e.g., D2 and D4) that are lit.

As illustrated in FIG. 4, in a case where the display gradation level in the unit area 5 is a third low gradation level that is higher than the zeroth gradation level and lower than the threshold gradation level and that differs from the first low gradation level, the number of the upper light-emitting elements (e.g., D1 and D7) that are lit may be the same as the number of lower light-emitting elements (e.g., D4 and D6) that are lit.

As illustrated in FIG. 2, in a case where K is a natural number and N (e.g., 8)=2×K (e.g., 4), the unit area 5 may include K (for example, four) sub-pixels P each consisting of an upper light-emitting element and a lower light-emitting element.

FIGS. 6 and 7 are each a schematic cross sectional view illustrating a relationship between an effective luminance of the upper light-emitting element and an effective luminance of the lower light-emitting element. Light from the lower light-emitting element passes through the upper light-emitting element. Accordingly, in a case where the luminance of light emitted from the upper light-emitting element is the same as that from the lower light-emitting element, the effective luminance of the lower light-emitting element (luminance that contributes to display) is lower than that of the upper light-emitting element.

Assume a case in which, as illustrated in FIGS. 6 and 7, the transmittance of light from the lower light-emitting element is 60% and the upper light-emitting element (D1, D3, D5, and D7) and the lower light-emitting element has a normalized luminance of 1.0. In this case, the effective luminance of the upper light-emitting element is 1.0 and the effective luminance of the lower light-emitting element (D2, D4, D6, and D8) is 0.6. In a case where the upper light-emitting element and the lower light-emitting element have a normalized luminance of 0.3, the effective luminance of the upper light-emitting element (D1, D3, D5, and D7) is 0.3 and the effective luminance of the lower light-emitting element (D2, D4, D6, and D8) is 0.18. In other words, the luminance of the sub-pixel (e.g., P1) is lower in a case where the lower light-emitting element (e.g., D2) is lit and the upper light-emitting element (e.g., D1) is unlit than a case where the lower light-emitting element (e.g., D2) is unlit and the upper light-emitting element (e.g., D1) is lit.

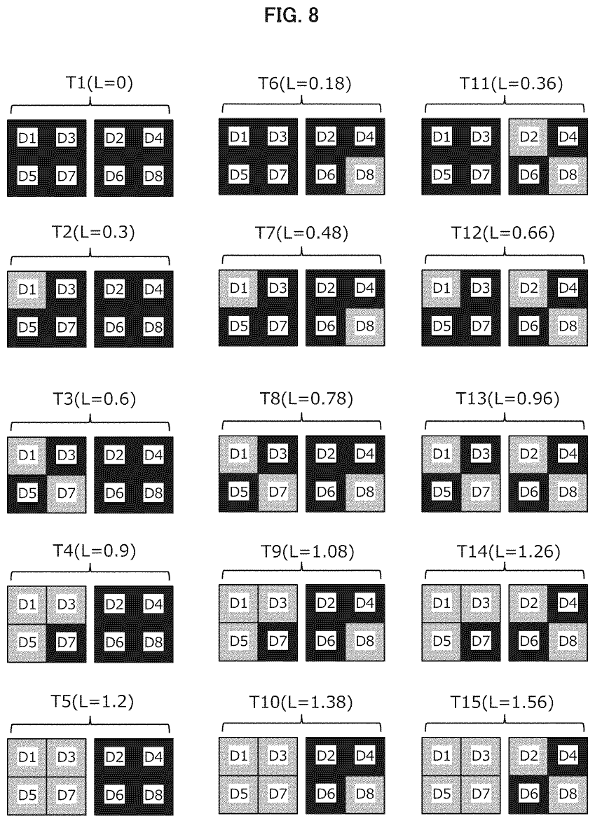

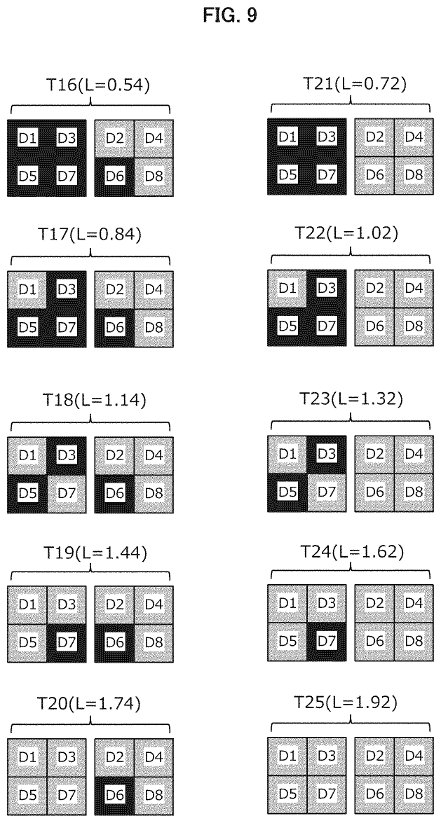

FIGS. 8 and 9 are each a schematic view illustrating light emission patterns of a plurality of light-emitting elements which are included in a unit area. In FIGS. 8 and 9, the normalized luminance of the upper light-emitting elements and the lower light-emitting elements are set to 0.3, the effective luminance of the upper light-emitting elements (D1, D3, D5, and D7) is 0.3, the effective luminance of the lower light-emitting elements (D2, D4, D6, and D8) is 0.18, and a sum of luminance L is a sum of effective luminance of D1 to D8.

In the light emission pattern T1, all of the light-emitting elements (D1 to D8) are unlit, and L=0. In the light emission pattern T2, the light-emitting element that is lit is D1, the light-emitting elements that are unlit are D2 to D8, and L=0.3. In the light emission pattern T3, the light-emitting elements that are lit are D1 and D7, the light-emitting elements that are unlit are D2 to D6 and D8, and L=0.6. In the light emission pattern T4, the light-emitting elements that are lit are D1, D3, and D5 and the light-emitting elements that are unlit are D2, D4, D6, D7, and D8, and L=0.9. In the light emission pattern T5, the light-emitting elements that are lit are D1, D3, D5, and 7 and the light-emitting elements that are unlit are D2, D4, D6, and D8, and L=1.2. In the light emission patterns T6 to T10, one additional lower light-emitting element (D8 having an effective luminance of 0.18) is lit in addition to the light-emitting elements that are lit in the light emission patterns T1 to T5, respectively. In the light emission patterns T11 to T15, two additional lower light-emitting elements (D2 and D8 having an effective luminance of 0.36) are lit in addition to the light-emitting elements that are lit in the light emission patterns T1 to T5, respectively. As illustrated in FIGS. 8 and 9, in the light emission patterns T16 to T20, three additional lower light-emitting elements (D2, D4, and D8 having an effective luminance of 0.54) are lit in addition to the light-emitting elements that are lit in the light emission patterns T1 to T5, respectively. In the light emission patterns T21 to T25, four additional lower light-emitting elements (D2, D4, D6, and D8 having an effective luminance of 0.72) are lit in addition to the light-emitting elements that are lit in the light emission patterns T1 to T5, respectively.

In this way, in a case where the N light-emitting elements (e.g., D1 to D8) are each subjected to binary control of lighting and non-lighting and the number of sums of luminance of the N light-emitting elements is M, M=(K+1)×(K+1) Then, if K (the number of sub-pixels in the unit area 5)=4, M=25 (ways). This corresponds to the light emission patterns T1 to T25.

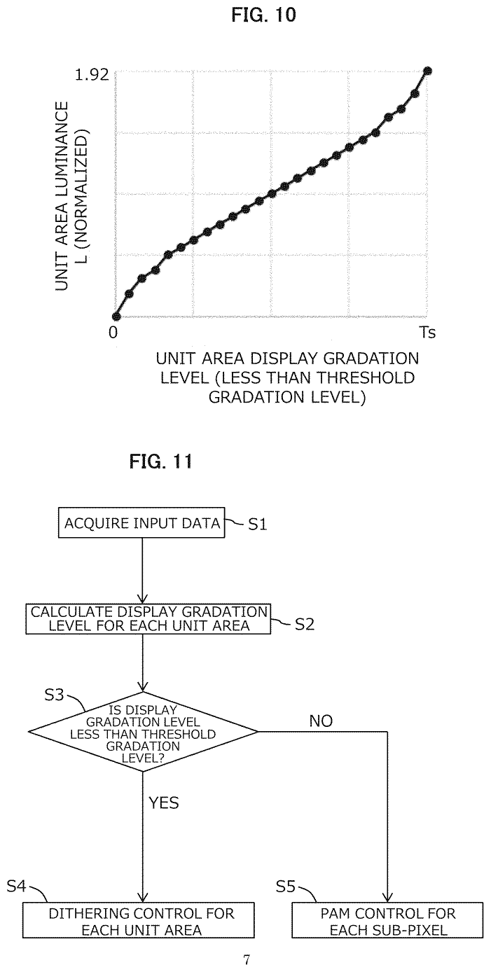

FIG. 10 is a graph showing a relationship between a display gradation level in a low gradation range and the sum of luminance in a unit area. With use of the light emission patterns illustrated in FIGS. 8 and 9, it is possible to assign, as illustrated in FIG. 10, the light emission pattern T1 (L=0) to the zeroth gradation level, the light emission pattern T25 (L=1.92) to the threshold gradation level Ts, and remaining (M−2) light emission patterns T2 to T24 corresponding to the sums of luminance (L=0.18 to 1.74) to a display gradation level range of higher than the zeroth gradation level to lower than the threshold gradation level Ts. In this way, it is possible to carry out display in a low gradation range from zero to the threshold gradation level Ts with use of a stable luminance (normalized luminance: 0.3) of the light-emitting element D illustrated in FIG. 3. The threshold gradation level Ts may be lower than a median value (128th gradation level) of an entire gradation level range (for example, the zeroth gradation level to 255th gradation level).

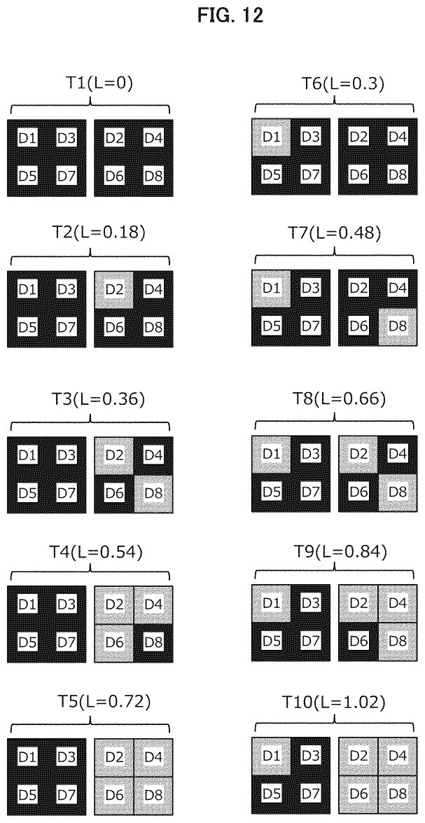

FIG. 11 is a flowchart showing a method for controlling the display device (operation of the control section). In step S1, input data is acquired. In step S2, a display gradation level is calculated for each unit area 5. In step S3, it is determined whether or not the display gradation level is lower than the threshold level. If YES (lower than the threshold gradation level Ts), the step proceeds to step S4, and dithering control is performed for each unit area 5. If No (not lower than the threshold gradation level Ts), the step proceeds to step S5, and pulse amplitude modulate control (PAM control) is performed for each sub-pixel. For example, in a case where the sub-pixel P1 is subjected to the PAM control, the luminance of the light-emitting elements D1 and D2 are controlled by controlling current flowing through the drive transistor Td of the pixel circuits X1 and X2. In the PAM control, it is possible to light the light-emitting element D at a stable luminance. The luminance of the light-emitting elements D that are to be lit in a case where the display gradation level is the first low gradation level (FIG. 4) may be not lower than the luminance of each of the sub-pixels P in a case where the display gradation level is the threshold gradation level Ts.

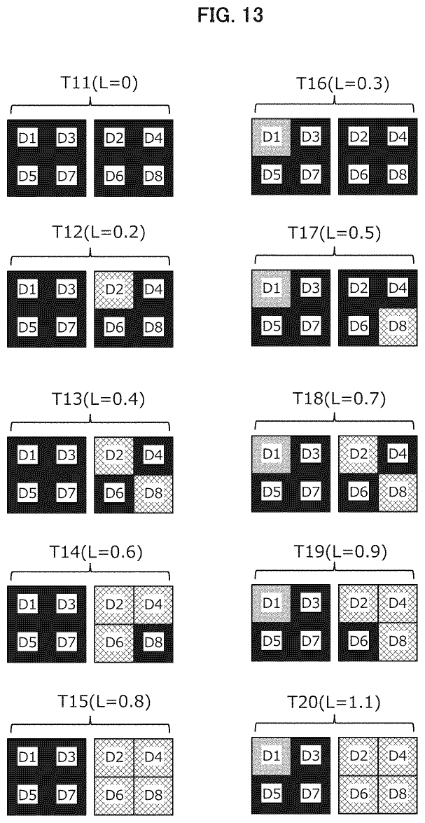

FIGS. 12 and 13 are each a schematic view illustrating light emission patterns of a plurality of light-emitting elements which are included in a unit area. In FIGS. 8 and 9, although the upper light-emitting elements are controlled by two values (lighting/non-lighting) and the lower light-emitting elements are controlled by two values (lighting/non-lighting), an embodiment of the present disclosure is not limited to this configuration. As illustrated in FIGS. 12 and 13, the lower light-emitting elements (D2, D4, D6, and D8) may be controlled by three values (brightly lit, dimly lit, and unlit). Light emission patterns T1 to T10 of FIG. 12 illustrate a case in which: the lower light-emitting elements (D2, D4, D6, and D8) are controlled by dim lighting/not lighting, and the upper light-emitting elements (D1, D3, D5, and D7) are controlled by dim lighting/not lighting (binary control); and the number of upper light-emitting elements that are to be dimly lit is set to 0 or 1. Light emission patterns T11 to T20 of FIG. 13 illustrate a case in which: the lower light-emitting elements (D2, D4, D6, and D8) are controlled by bright lighting/non-lighting, and the upper light-emitting elements (D1, D3, D5, and D7) are controlled by dim lighting/non-lighting (binary control); and the number of upper light-emitting elements that are to be dimly lit is set to 0 or 1. The normalized luminance of the upper light-emitting element (one element) that is dimly lit is 0.30, and the effective luminance of the lower light-emitting element (one element) that is dimly lit is 0.18 (normalized luminance: 0.30, and transmittance: 60%), and the effective luminance of the lower light-emitting element (one element) that is brightly lit is 0.20 (normalized luminance: 0.34 and transmittance: 60%).

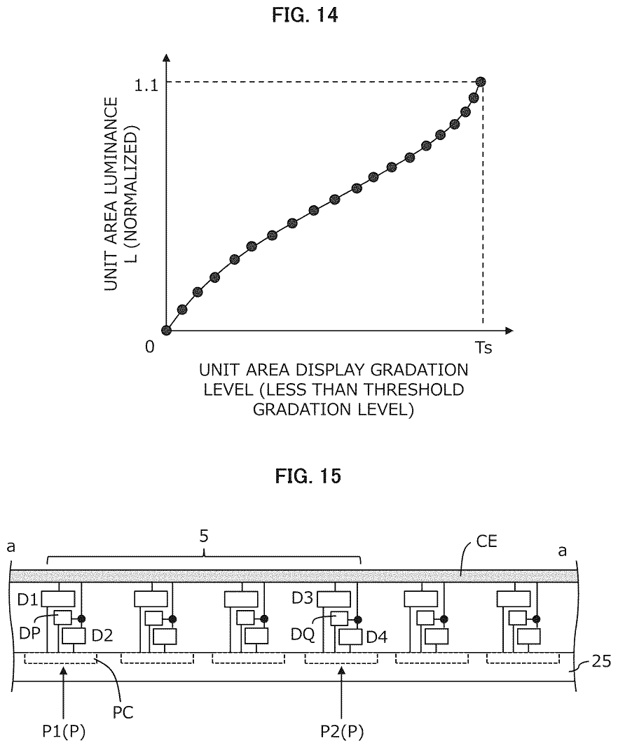

FIG. 14 is a graph showing a relationship between a display gradation level in the low gradation range and the sum of luminance in a unit area. With use of the light emission patterns illustrated in FIGS. 12 and 13, it is possible to assign, as illustrated in FIG. 14, the light emission patterns T1 and T11 (L=0) to the zeroth gradation level, the light emission pattern T20 (L=1.1) to the threshold gradation level Ts, and remaining light emission patterns T2 to T19 (excluding T11) of the sums of luminance (L=0.18 to 1.02) to a display gradation level range of higher than the zeroth gradation level to lower than the threshold gradation level Ts. In this way, it is possible to display a low gradation range from zero to the threshold gradation level Ts with use of a stable luminance (normalized luminance: not lower than 0.3) of the light-emitting element D illustrated in FIG. 3. In FIGS. 12 and 13, the number of the upper light-emitting elements that are dimly lit is controlled to be 0 or 1. However, an embodiment of the present disclosure is not limited to this configuration. The number of the upper light-emitting elements that are dimly lit may be set to 0, 1, 2, 3, or 4.

The unit area 5 may include a plurality of light-emitting elements (e.g., D11 and D12) that emit light of a second color and a plurality of light-emitting elements (e.g., D13 and D14) that emit light of a third color, as illustrated in FIG. 2. The light-emitting element D may include an organic light emitting layer or a quantum dot light emitting layer. The first color may be one of primary colors including red, blue, and green, and the second color and the third color may be remaining two primary colors, respectively.

FIG. 15 is a cross sectional view illustrating a configuration example of a display section. As illustrated in FIG. 15, a plurality of light-emitting elements that are included in the unit area 5 consist of: one or more upper light-emitting elements (D1 and D3); one or more lower light-emitting elements (D2 and D4) that overlap with the one or more upper light-emitting elements in plan view; and one or more intermediate light-emitting elements (DP and DQ) that are located between the one or more lower light-emitting elements (D2 and D4) and the one or more upper light-emitting elements (D1 and D3).

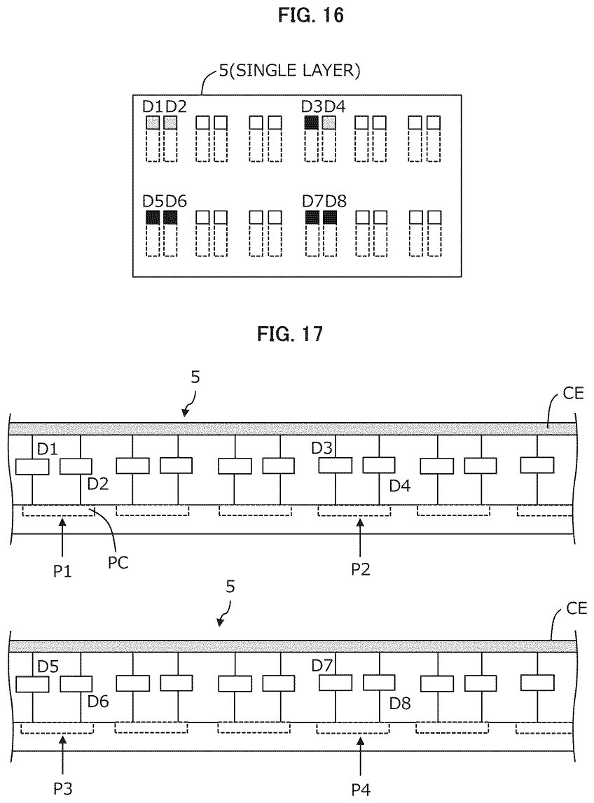

FIG. 16 is a plan view illustrating a configuration example of a display section. FIG. 17 is a cross sectional view illustrating a configuration example of the display section. As illustrated in FIGS. 16 and 17, the plurality of light-emitting elements (D1 to D8) that are included in the unit area 5 may be arranged in a plane manner. For example, in a case where the display gradation level of the first color in the unit area 5 is to be set to a first low gradation level which is higher than the zeroth gradation level and lower than a threshold gradation level, it is possible to control the unit area 5 such that the N light-emitting elements (for example, the eight light-emitting elements D1 to D8) include light-emitting elements (e.g., D1, D2, and D4) that are lit and light-emitting elements (e.g., D3, D5, D6, D7, and D8) that are unlit.

### Additional Remarks

Embodiments described above are intended to provide examples and explanations, but are not intended to limit the scope of claims. On the basis of the examples and the explanations, it is evident to a person skilled in the art that many variations can be made.

### Reference Signs List

5 unit area
10 display device
11 first driver
12 second driver
20 display section
25 pixel circuit substrate
30 control section
Ts threshold gradation level
P1 to P4 sub-pixel
D1 to D8 light-emitting element
T1 to T25 light emission pattern

1. A display device comprising a display section and a control section that controls the display section,
the display section having a unit area including N light-emitting elements that emit light of a first color, where N is an integer of 2 or more, and
the control section controlling the unit area such that, in a case where a display gradation level of the first color in the unit area is set to a first low gradation level that is higher than zeroth gradation level and lower than the threshold gradation level, the N light-emitting elements include a light-emitting element which is lit and a light-emitting element which is unlit,
wherein the N light-emitting elements consist of one or more upper light-emitting elements and one or more lower light-emitting elements that overlap with the one or more upper light-emitting elements in plan view.

2. The display device according to claim 1, wherein the number of light-emitting elements that are lit is larger in a case where the display gradation level is a second low gradation level, which is higher than the first low gradation level and lower than the threshold gradation level, than in a case where the display gradation level is the first low gradation level.

3. The display device according to claim 2, wherein the light-emitting element that is lit has a luminance that does not change between a case where the display gradation level is the first low gradation level and a case where the display gradation level is the second low gradation level.

4. (canceled)

5. The display device according to claim 1, wherein, in a case where the display gradation level is the first low gradation level, the number of the upper light-emitting elements that are lit differs from the number of the lower light-emitting elements that are lit.

6. The display device according to claim 5, wherein, in a case where the display gradation level is higher than the zeroth gradation level and lower than the threshold gradation level and is different from the first low gradation level, the number of the upper light-emitting elements that are lit is the same as the number of the lower light-emitting elements that are lit.

7. The display device according to claim 1, wherein, in a case where K is a natural number and N=2×K, the unit area includes K sub-pixels each consisting of a lower light-emitting element and an upper light-emitting element.

8. The display device according to claim 7, wherein the sub-pixels have a luminance that is lower in a case where the lower light-emitting elements are lit and the upper light-emitting elements are unlit than a case where the lower sub-light-emitting elements are unlit and the upper light-emitting element are lit.

9. The display device according to claim 8, wherein, in a case where each of the light-emitting elements is subjected to binary control of lighting and non-lighting and the number of sums of luminance of the N light-emitting elements is M, M=(K+1)×(K+1).

10. The display device according to claim 9, wherein sums of luminance of (M−2) ways are assigned to a display gradation level range that is higher than the zeroth gradation level and lower than the threshold gradation level.

11. The display device according to claim 1, wherein the threshold gradation level is lower than a median value of an entire gradation level range.

12. The display device according to claim 1, wherein the unit area includes a plurality of light-emitting elements that emit light of a second color and a plurality of light-emitting elements that emit light of a third color.

13. The display device according to claim 7, wherein, in a case where the display gradation level is a non-low gradation level which is not lower than the threshold gradation level, the control section controls each of the K sub-pixels such that the sub-pixels each have a luminance corresponding to the non-low gradation level.

14. The display device according to claim 13, wherein the control section determines, on the basis of an input image, whether to control the display section for each unit area or for each sub-pixel.

15. The display device according to claim 13, wherein the luminance of the light-emitting element that is to be lit in a case where the display gradation level is the first low gradation level is set in accordance with a voltage-luminance characteristic of the light-emitting element.

16. The display device according to claim 13, wherein the luminance of the light-emitting element that is to be lit in a case where the display gradation level is the first low gradation level is not lower than the luminance of each of the sub-pixels in a case where the display gradation level is the threshold gradation level.

17. The display device according to claim 1, wherein each of the N light-emitting elements include an organic light emitting layer or a quantum dot light emitting layer.

18. A display device comprising a display section and a control section that controls the display section,
the display section having a unit area including N light-emitting elements that emit light of a first color, where N is an integer of 2 or more, and
the control section controlling the unit area such that, in a case where a display gradation level of the first color in the unit area is set to a first low gradation level that is higher than zeroth gradation level and lower than the threshold gradation level, the N light-emitting elements include a light-emitting element which is lit and a light-emitting element which is unlit,
wherein the N light-emitting elements consist of: one or more upper light-emitting elements; one or more lower light-emitting elements that overlap with the one or more upper light-emitting elements in plan view; and one or more intermediate light-emitting elements that are located between the one or more lower light-emitting elements and the one or more upper light-emitting elements.

19-20. (canceled).

21. The display device according to claim 18, wherein the number of light-emitting elements that are lit is larger in a case where the display gradation level is a second low gradation level, which is higher than the first low gradation level and lower than the threshold gradation level, than in a case where the display gradation level is the first low gradation level.

22. The display device according to claim 21, wherein the light-emitting element that is lit has a luminance that does not change between a case where the display gradation level is the first low gradation level and a case where the display gradation level is the second low gradation level.
